(19) United States
(12) Patent Application Publication
(10) Pub. No.: US 2010/0246930 A1
(43) Pub. Date: Sep. 30, 2010

(54) INSPECTION APPARATUS AND METHOD USING PENETRATING RADIATION

(75) Inventors: Alain Dekker, Woking (GB); Jon Burgess, Hampshire (GB)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ILLINOIS TOOL WORKS INC., Glenview, IL (US)

(21) Appl. No.: 12/669,105

(22) PCT Filed: Jul. 9, 2008
(86) PCT No.: PCT/US08/69504

§ 371 Date: Jun. 8, 2010

(30) Foreign Application Priority Data
Jul. 16, 2007 (GB) 0713781.3

(51) Int. Cl. G06K 9/00

(52) U.S. Cl. 382/141

(57) ABSTRACT

Products in multiple lanes are passed side-by-side through X-ray inspection apparatus and an image is acquired. Different parts of the image corresponding to the different product lanes are subjected to different numerical processing, so that product anomalies are in each case readily visible or reliably detected using automatic threshold discrimination. The same X-ray power may therefore be used to inspect products having widely different X-ray attenuation characteristics.

### AIM

The present invention relates to a method and apparatus which uses penetrating radiation to effect non-contact analysis of an object.

### INTRODUCTION

It is known to use penetrating radiation such as X-rays to monitor and inspect products in a production process.

In a typical production process, the product is inspected at various stages to ensure product integrity prior to final packaging and dispatch of the product. In the commercial processing of foodstuffs for example, product integrity may involve one or more of the following: ensuring that each portion of foodstuff has the correct weight, contains no contaminants or product anomalies, the correct number of packs is contained within a multi-pack and the proper amounts of product are contained in each pack. For example in the production of prepared meals comprising a number of pouches or sachets which are packaged in an outer wrapper, it is necessary to inspect the packages to determine that all of the pouches or sachets are present and correctly filled.

In a conventional device for inspecting products such as prepared meat, other foodstuffs, or any other materials permeable to X-rays, a conveyor is provided for transporting the products through an inspection zone. A source of X-rays is located adjacent to the inspection zone and directs a beam of X-rays through the products as they are carried through the inspection zone on the conveyor. The X-ray beam is typically shaped by a pair of aperture plates to form an irradiation zone through which the products pass. The irradiation zone is narrow in the conveying direction but sufficiently broad in the orthogonal directions to irradiate each product entirely as it passes through the inspection zone on the conveyor. In alignment with the irradiation zone, and opposite the x-ray source with respect to the path of travel of the products, a linear array of photodiodes is arranged. A phosphorescent strip is mounted next to the array of photodiodes, so that X-rays from the source pass between the aperture plates, through the product, and strike the phosphorescent strip. Each point along the length of the phosphorescent strip emits visible light in proportion to the strength of the X-ray radiation striking the strip at that point, and this visible light is converted by the array of photodiodes into electrical signals. The signal from each photodiode represents the strength of the X-ray beam at that point along the array. Typically the X-ray source and the detector components are positioned one above and the other below the conveyor, with the photodiode array extending transversely to the conveyor's direction of movement. However other arrangements are possible, for example with the X-ray source and detector transversely opposed on either side of the conveyor.

The intensity of the X-ray radiation striking the phosphorescent strip at any one time is dependent upon the physical parameters associated with the product such as density and thickness. A variation in the thickness or density causes the amount of light emitted at each point along the length of the phosphorescent strip to be modulated. The array of photodiodes detects this modulated light emission, and by repeatedly sampling the outputs of the individual photodiodes in the linear array, the product is scanned as it passes through the irradiation zone. The outputs of the photodiodes are conventionally displayed as a video image of the passing product.

In the case of prepared meat products for example, any bones remaining will resist penetration of X-rays to a greater extent than will the meat, and thus the photodiode which falls in the “shadow” of the bone will be illuminated to a lesser extent than will photodiodes which receive X-rays passing through the meat. Thus the presence of any bone or other body more resistant to X-rays can be detected in the video image as a dark area. The product concerned may then either be re-processed or discarded from the production line.

In an alternative use for the inspection equipment, the absence of the product may be detected. For example, in the final inspection of multipacks of food items such as cakes or pies, the packages may pass through the irradiation zone and the photodiode outputs are used to form a video image of the packaged items. By monitoring the image, the number of items present within the package can be verified, since a missing item appears as a lighter image area than would otherwise be expected.

Verification of the presence or absence of foodstuffs may involve comparing the detected light level with a predetermined “ideal image” by the operative monitoring the video display. A decision is made on the basis of whether the image is too dark, when foreign bodies are to be detected, or the image is too bright when the absence of an inspected item is to be detected.

Other conventional machines for monitoring the product integrity known in the art include the use of metal detectors and a gravitational checkweigher.

The demand for bulk processed foodstuffs is increasing, and food retailers are increasingly placing strict controls upon their suppliers to ensure that all due care has been taken to ensure that their products are free from contaminants. Demands for effective quality control with rapid, minimum cost production, are ever-present in other sectors, too. There is therefore an increasing need for manufacturers to monitor the integrity of their products quickly and effectively prior to final packaging and dispatch. In many detection devices and inspection lines the individual products or packages can only be inspected sequentially. The limiting factor is therefore the speed of the conveyor by which the product is moved through the detection zone. However, increasing the speed of the conveyor causes the product to move faster through the detection zone which is reflected in a loss in quality of the analysis. For example in a conventional X-ray detection device as described above, the faster the product passes through the irradiation zone, the smaller the integration time on the diode array which in turn causes a decrease in signal-to-noise ratio which reduces the quality of the image taken using the X-rays. High conveyor speeds are inherently undesirable as they lead to product handling problems. Furthermore an inspection machine will usually be chosen on the basis of the largest products that it will have to handle, but will often be used for some of the time to inspect much smaller products. A significant proportion of the detection zone is then unused, resulting in under use of the capital equipment.

Multiple product inspection lines can be used to increase throughput without increasing line speed. Conventionally, this has required a separate inspection machine for each product line. This also meant multiple conveyor systems to distribute the products to the machines and to recombine the products after inspection. The complexity and cost of this is high. With an X-ray machine which inspects by taking an image of the product, it is possible to split the image and therefore simulate multi-lane operation. This allows multiple product lines to pass through one machine simultaneously, dramatically increasing throughput. There is also potential for maximising the use of the detection zone, no matter what the size of product.

Multi-lane techniques in which more that one product item is analysed side-by-side in a single inspection machine are effective where the inspected items are similar in terms of properties such as thickness, density and surface texture, so that the penetrating radiation is attenuated to a similar extent by products in each lane. However, multi-lane inspection techniques become problematic when different product types are present, e.g. one lane of relatively homogeneous products such as cheese and another lane of products having a dense, relatively hard crust and a less dense, relatively soft interior, such as a baguette. For denser products, higher X-ray power may be required in order to distinguish features in darker parts of the image. However, applying too much power to a low density product, results in a “washed out” image. In the situation where two different lanes of products are passed through the X-ray machine, one very dense and one of low density, it is not possible to apply a different X-ray power to each lane.

An analysis method and apparatus is thus required that has the ability to monitor and inspect the product integrity with multi-lane throughput regardless of the differences in product type or condition between the different lanes.

### SUMMARY OF THE INVENTION

In accordance with the present invention, there is provided a method of inspection comprising the steps of:

a) acquiring an image of an inspection zone; b) numerically processing the image, in which first and second parts of the image are subjected to impendent numerical processing; c) passing a first series of items through the inspection zone so as to appear in the first part of the image, and d) passing a second series of items through the inspection zone so as to appear in the second part of the image. Different kinds of items to be inspected appearing in the different parts of the image can therefore be subjected to different numerical processing for example to optimise anomaly discrimination separately and preferably simultaneously for the different kinds of item.

Inspection with multi-lane throughput can be performed by splitting the image into portions corresponding to different lanes and independently processing each portion of the image, e.g. so that a contrast between features to be discriminated in the different lanes, such as product anomalies, are all made more visible. In one embodiment, the inspection method therefore comprises the further step of passing a first kind of item to be inspected and a second kind of item to be inspected through the inspection zone; the first kind of item appearing in one of the different parts of the image and the second kind of item appearing in another of the different image parts. This allows products to be monitored or inspected simultaneously, so increasing through-put of the inspected items through the inspection device, even in the case of items having substantially different attenuation effects on the penetrating radiation. Moreover, the full width of the inspection zone can thus be used, making more efficient use of the inspection device. A source of penetrating radiation can be used to acquire the image, operated at the substantially the same power for all portions of the inspection zone used to form the image.

Preferably the penetrating radiation is X-rays and the inspection device comprises of a detector having at least one sensor which generates a signal in response to the penetrating radiation incident upon it. The signal is used to generate the image. More preferably the image processing step comprises independently processing data representing the different image parts.

The image processing preferably comprises applying an image processing algorithm or algorithms independently to the data representing the different image parts. Preferably the image processing algorithm or algorithms apply a gamma correction to the data. Ordinarily gamma correction is used for example to correct the contrast of visual display images and can be performed by either software or hardware. Gamma correction is used to correct for the case where the brightness of the visual display is non linear, i.e. the light intensity (brightness) distribution of the display is adjusted in order to match the output more closely to the original image. When gamma is less than one and the lighter areas of the display image appear correctly, the darker areas of the image appear too light. When gamma is greater than one and the lighter areas of the image appear correctly, the darker areas of the image appear too dark. The required gamma correction is given by the inverse of gamma.

By applying a different gamma correction independently for different ones of the different image parts, in an embodiment of the contrast of each image part can effectively be controlled independently. Thus areas of any image part which appear too dark for reliable contaminant detection (e.g. when a dense product such as chicken breast meat is being inspected in that image part) can be effectively lightened by applying the gamma correction to the signal representing that image part so that any contaminants or imperfections in the product (bone splinters, for example) can be more easily made out by visual inspection or be reliably discriminated automatically by appropriate threshold detection applied to the image signal. Conversely areas of the image of the product which appear too light (washed out) can be darkened by applying a different gamma correction to the signal representing that image part such that contaminants or anomalies can again easily be made out or reliably detected automatically. Preferably the gamma correction factor ranges from substantially 0.2 to 6.0 independently for different image parts.

In an embodiment of the present invention, in one or more of the different image parts, areas of the image part having a brightness greater than a threshold value (for example parts of the image containing no items to be inspected and which are therefore of no interest in the inspection process) are set to the maximum image brightness. The brightness range of the remaining areas of that image part is increased. This process in effect removes or ignores image data in those areas of the image part of no interest in the inspection process, and expands the variation in the remaining image data (essentially relating to the items under inspection, in most cases) amplifying any anomalies present and allowing them to be more reliably discriminated.

The determination of the or each threshold value firstly involves applying a range factor, RANGE, to a raw data target calibration value, RAW_TARGET; this value RAW_TARGET corresponding to the detected brightness where only the penetrating radiation (and no product) is being imaged. Preferably the range factor RANGE is substantially from 20% to 120%. The image data preferably comprises discrete brightness values of a plurality of pixels forming the image. The image is divided into a plurality of pixels each having a discrete brightness. The unprocessed image data may have one number of bits (e.g. 16 bits per pixel) image and the processed image data may be represented using a different number of bits, such as an 8 bits per pixel image for the display unit. By removing some of the data in the raw image, the brightness variations in the remaining data can effectively be ‘stretched’ to fit the number of bits available in the processed image. This allows ranges of contrast of interest in the image to be expanded allowing any contaminants to stand out from the normal brightness levels of an uncontaminated item under inspection. For each image part, the processed image data which is not set to the maximum brightness or ignored, may be calculated by the following algorithm:

Map[data]=DATA_MAX_PROCESSED*(Data/ModifiedTarget)^{(1.0/Gamma)}

where:
Map is a table that defines what a pixel value in the raw image will be converted to in the processed image;
DATA_MAX_PROCESSED is the maximum integer value for a pixel in the processed image;
Data is a given pixel value in the raw (unprocessed) image;
ModifiedTarget is the threshold value of Data below which the algorithm is applied, given by the expression:

ModifiedTarget=(RAW_TARGET*RANGE)/100

where RAW_TARGET and RANGE are as defined above; and
1.0/Gamma is the gamma correction factor.

Different values of the gamma correction factor and RANGE may be used for each different image part.

Further preferred features and aspects of the present invention will be apparent from the claims and the following illustrative description made with reference to the accompanying drawings.

### BRIEF DESCRIPTION OF THE DRAWINGS

FIG. 1 is a schematic representation of an X-ray inspection device;

FIG. 2 is a plan view of the device of FIG. 1 showing twin product lanes;

FIG. 3 shows images of identical uncooked chickens produced from the twin lane device of FIGS. 1 and 2, using different gamma values for each lane;

FIG. 4 shows images corresponding to those of FIG. 3, but with different values of RANGE and the gamma set to the default value 1.0 for each lane;

FIG. 5 shows further images of the uncooked chickens with further values of RANGE and gamma;

FIG. 6 is a brightness profile on the line X-X of the processed image of the chicken in Lane A shown in FIG. 3, and

FIG. 7 is a brightness profile on the line Y-Y of the processed image of the chicken in Lane B shown in FIG. 3.

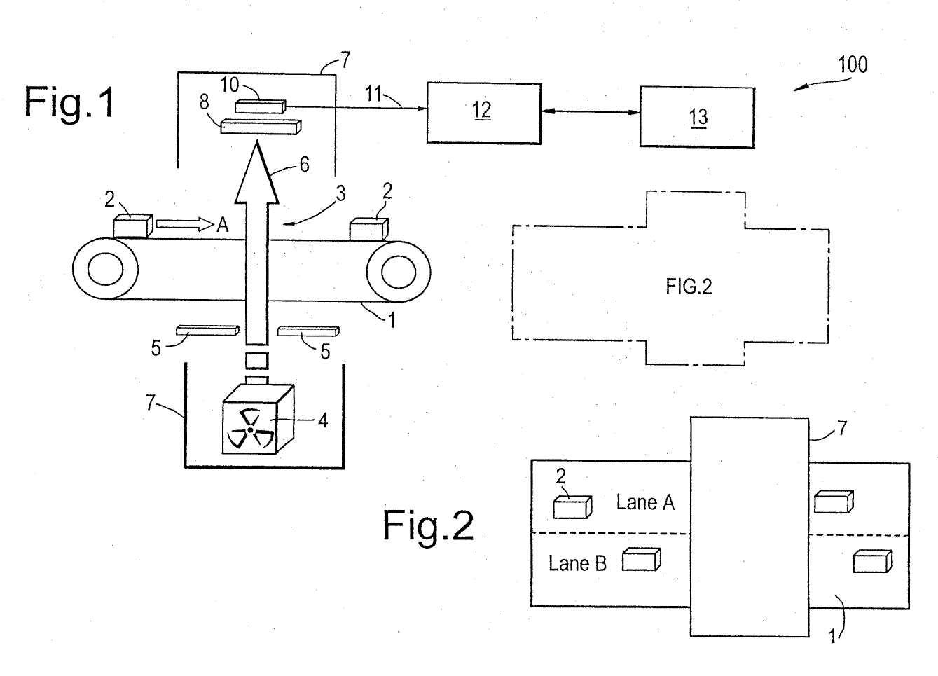

An inspection device 100 which can be used in an embodiment of the present invention is shown in FIG. 1. It comprises is an X-ray inspection device known in the art (see e.g. U.S. Pat. No. 6,347,131) having a conveyor 1 for carrying a series of products 2 at a known speed through an inspection zone 3 of the device in the direction of the arrow C. The product may be any radiation permeable substance or object, such as pharmaceutical preparations, and is not limited to foodstuffs. The products as shown in a plan view (see FIG. 2) are supported on a conveyor having twin product lanes A and B whereby two different series of products are carried through the inspection zone side by side in the lanes A, B.

A radiation source 4 and a pair of aperture plates 5 are positioned adjacent to the conveyor (below it, as shown). The aperture plates 5 are opaque to the radiation from the source 4, and shape an irradiation zone or beam 6 of substantially planar configuration, orientated orthogonal to the conveying direction A. The radiation source 4, aperture plates 5, inspection zone 3, and the detector formed by a phosphorescent strip 8 and photodiode array 10, are contained within suitable biological shielding 7.

Situated opposite the radiation source with respect to the conveyor 1 and aligned with the irradiation zone 6 is a phosphorescent strip 8, beyond which is disposed a linear array 9 of photodiodes 10. The phosphorescent strip 8 is sensitive to the radiation beam 6, and emits visible light towards the photodiodes 10 in response to the radiation beam incident upon it. The output signal from the photodiode array, after any necessary pre-processing such as temperature compensation and analogue to digital conversion, is supplied via a connection 11 to a processor 12 which may be a personal computer having a user interface such as a touch screen 13. Alternatively the data processor may be any other suitable programmable computer or microprocessor, or any other dedicated electronic circuitry capable of carrying out the necessary data processing operations as described in this specification.

In terms of the digital output of the diode array, it is desirable that the range of each diode is divided into the same number of steps or brightness levels, so that each diode output will correspond to one of a predetermined number of illumination levels. In a typical application using an 8-bit image the range of each diode can be divided into 256 steps or discrete brightness levels. This means that for a typical 8-bit image each pixel in the image is divided into discrete brightness levels between absolute black (0) and absolute white (255). The value of each pixel or brightness level is therefore proportional to the energy of the X-rays incident on the detector at any one time. However, the number of discrete steps is not restricted to 8-bits per image pixel and 12, 14 and 16 bits could be substituted, for example. This raw image data may be converted to data having a different number of bits in the processed image described further below: e.g. 16 bit raw image data converted to 8 bit processed image data.

By applying image processing independently to the portion of the signal represented by the first product in Lane A and the second product in Lane B, the user can simultaneously and reliably inspect products having markedly different X-ray attenuation properties using a constant X-ray power level. The image obtained from the diode array is split into two different parts representing the product lanes A and B respectively. The signal from the detector represents the raw signal data and is represented as discrete brightness levels of a plurality of pixels.

The image processing involves independently processing the raw image data representing the inspection zone in lane A and the inspection zone in lane B by separately applying an image processing algorithm to each of these image parts. The image processing algorithm involves applying a gamma correction independently to each of the raw signal data representing the image parts. RANGE adjustment may also be separately applied to the two different image parts as described above.

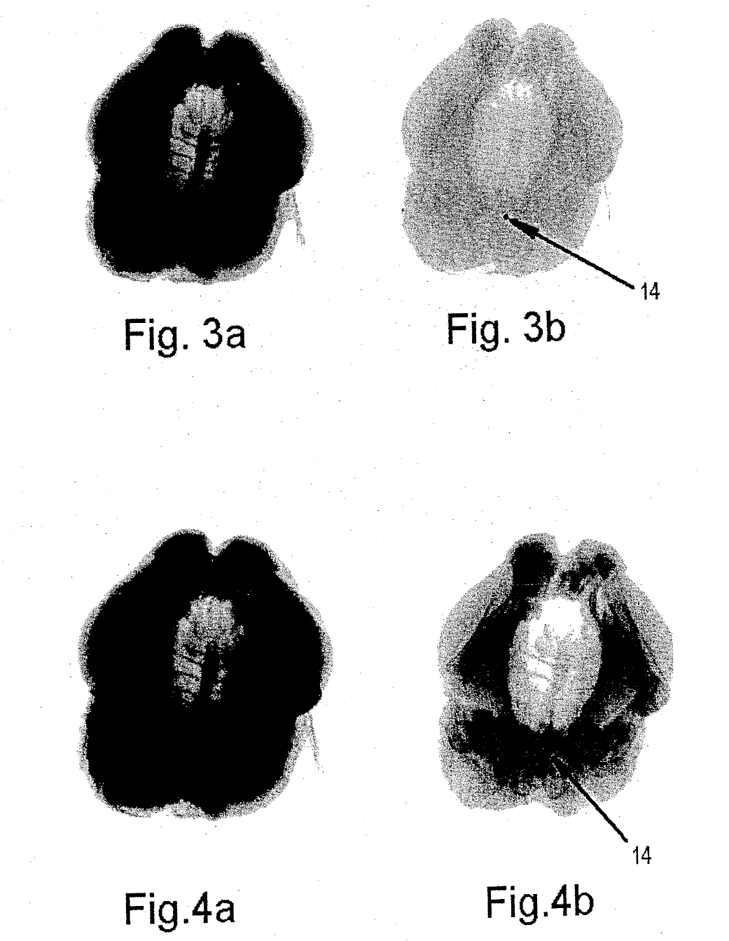

FIG. 3 shows an X-ray image generated by the twin lane system showing an identical uncooked chicken that has been passed down lanes A and B. The uncooked chicken contains a 2.5 mm diameter stainless steel ball bearing as a contaminant test piece. In both cases the X-ray power was set to 60 kV and 0.6 mA but the power level is not restricted to this level and other power levels can be used as appropriate to a particular product or combination of products under inspection. The left-hand image part for lane A shows the situation where the signal from the detector is processed with Gamma at its 1.0 default level and RANGE set to 100%. The image appears dark such that any contaminant in the uncooked chicken (represented by the ball bearing test piece) is not easily visible. This X-ray power level in conjunction with these settings for Gamma and RANGE is therefore better suited to a product that is more transparent to X-rays, for example a thinner or less dense product than the chicken.

The right-hand image part for lane B shows the situation where the image part has been processed with RANGE=100% as before, but in this case the gamma correction factor, 1.0/Gamma, was set to 2.4. Thus none of the raw image data has been discarded, but the pixel values of the processed image have been compressed towards higher values (lighter image) by the gamma correction. Here the ball bearing 14 can easily be seen as a small black dot (circled in the drawing) even though the X-ray power remains unchanged. The image processing in the case of FIG. 3 is applied over the full range of the image data but the gamma correction value is varied as between the left and right hand parts of the image, corresponding to lanes A and B respectively. For the left hand side of the image no gamma correction is applied, i.e. Gamma is set to the default value of 1.0. But in the right hand side of the processed image the gamma correction value, 1.0/Gamma, has been increased to 2.4 and so that part of the image appears lighter as more of the pixel data are pushed towards the higher pixel range. Typically the correction factor, 1.0/Gamma, may be set anywhere from 0.2 to 6.0 as dictated by the properties of the product in the lane concerned and the X-ray power used. However the present invention is not restricted to these values and any other value of the gamma can be used as may be required to improve the contrast of the image part concerned.

To complement or substitute for the gamma value, the portion of the signal that is processed may be controlled for different parts of the image independently, using corresponding settings of the RANGE parameter. For example any of the raw image data representing the light areas outside the products under inspection may be discarded and the signal representing the darker areas can be expanded to occupy a larger contrast range. The image data that are discarded or removed could represent other “non-product” areas e.g. packaging. Conversely the range could be used to concentrate on the lighter areas of the image and discard parts of the signal represented by the darker areas.

Determining the portion of the signal that is processed involves scanning through the raw image data and processing pixel values that are below a raw data target threshold value. Raw data that is above this target threshold value is discarded, e.g. set to the maximum possible processed data pixel value (“white”). The raw data target threshold value is a modified target value which represents a proportion of the maximum raw data value controlled by the RANGE factor. For example because the signal from the detector is represented as discrete pixel values, the maximum raw signal value and the maximum pixel value as a result of conversion of the analogue signal from the detector to a digital signal may be 8-bit, 12-bit, 14-bit, 16 bit and so on. In any case the maximum possible pixel value represents 100% lightness (“white”) at one end of the grey scale. For a 16-bit image the maximum possible pixel value is 2¹⁶. However, in the determination of the raw data target threshold value, a raw data target calibration value is used instead of the maximum possible raw pixel value. The raw data target calibration value takes into account that when product is absent, the detector will be fully irradiated and therefore returning the maximum pixel value in the raw image. This maximum value must allow for temperature drift, small X-ray power fluctuations and the fact that the X-ray power will usually (and desirably) be lower than that which will saturate the detector diodes. Thus the raw data target calibration value is always less than the maximum possible raw data value.

The processed data may be confined to a different maximum value and hence maximum pixel value compared to the maximum raw image data, e.g. 16-bit raw image data could be processed to form an 8-bit processed image. In the following this is termed the maximum possible processed image data value (e.g. 2⁸−1 for 8-bit processed data). In the determination of the raw image data that is processed, the processor scans through the raw image data from the detector. The raw data threshold target value and thus the proportion of the raw signal that is processed are determined by applying a range factor to the raw data target calibration value. The range factor could be 20% through to 120% but is not restricted to these values. Any raw data that is above the threshold value given by the raw data target calibration value multiplied by the range factor is set to the maximum possible processed pixel value and so appears white (discarded) and any of the data below this threshold value is processed.

The signal target threshold value is thus given by the equation:—

raw data target threshold value=(raw data target calibration value×range factor)/100

By way of illustration, consider the theoretical case whereby the range factor is 100% and the raw data target calibration value is equal to the maximum possible pixel value, so all the data in a 14-bit raw data image having a maximum pixel value of 2¹⁴−1 (=16383) get directly converted into an 8-bit processed image having a maximum pixel value of 2⁸−1 (=255). This means that 14-bit data gets converted to 8-bit data and to effectively convert to an 8-bit image the signal needs to be grouped into 256 divisions, where each division is 64 in size. (2¹⁴/2⁸=2⁶=64). Thus the values in the raw image in the range 0-63 are converted to a value of 0 in the processed image. Similarly, values in the range 64-127 in the raw image are converted to value 1 in the processed image, and so on up to 16383 in the raw image and 255 in the processed image. For the situation where a range factor of 20% is applied only values from 0 to 3277 will be converted into the 8-bit image. (If RANGE=20% then the maximum value in the raw image that will be converted=214*0.2≈3277). Anything higher than 3277 is converted to white. This means the divisions or bin size are much smaller, i.e. 0-13 represent 0, 14-27 represent 1, 28-41 represent 2 and so on up to 255. Taking a raw image pixel value of 135, in the first example with a range factor of 100% the pixel value is converted to 2 in an 8-bit image which is almost black. In the second example the pixel value is now converted to 9 (not so black), i.e. pushed up the lightness scale.

The image processing algorithm which is applied to the selected portion of the raw image data is given by:—

Processed image data=(maximum possible×(raw image data/raw data target threshold value)^{(1/Gamma)}processed data value)

A computer algorithm for carrying out these image processing steps and applying RANGE and Gamma to the raw image data is as follows:

```
ModifiedTarget = (RAW_TARGET*Range)/100
for Data=0 to DATA_MAX_RAW
    if (Data > ModifiedTarget) then
        Map[Data] = DATA_MAX_PROCESSED
    else
        Map[Data] = DATA_MAX_PROCESSED *
        [Data/ModifiedTarget]^{(1.0/Gamma)}
Next Data
```

where
RAW_TARGET is the target calibration value, usually equal to the maximum value in the raw image data where there is no inspected item present and only X-rays are being imaged;
DATA_MAX RAW is the maximum possible integer value for a pixel in the raw image, and the remaining variables are as defined in the introduction above.

The effect of applying a different range factor is shown in FIG. 4. Here RANGE is changed from the default value of 100% to 50% for the lane B part of the image; the lane A part retaining the same default Gamma and RANGE values as the lane A part of FIG. 3. By changing the RANGE value to 50% the high value raw image pixel data is discarded (set to white in the processed image), and the darker raw pixel data is stretched or expanded so as to provide increased contrast. Without changing the range factor compared to the lane A image part, the lane B image part appears brighter and the ball bearing 14 is therefore easily visible.

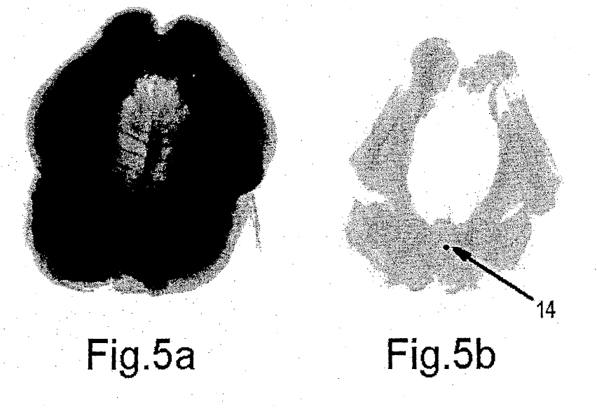

On the other hand, the effect of changing both the gamma value and the range is shown in FIG. 5. In this case, the lane B image part is further lightened by applying a range factor of 50%, together with a gamma value, 1.0/Gamma, of 2.4. As a result the pixel values in the processed lane B image part have been further pushed up the lightness scale. The lane A image part retains the default Gamma and RANGE values.

Thus by independently varying the gamma value and the range factor the user can adjust the brightness and the contrast of the image for each separate image portion along each lane. This can be done manually or can be automated. Any product anomaly such as a contaminant, in this case the stainless steel ball bearing, in any lane can easily be distinguished from the background. The processed image parts corresponding to each lane can be adjusted to suit widely different product or object types being inspected side by side at a single X-ray power.

Due to the increased contrast between the contaminant and the background, automatic profiling and threshold detection can be applied to the processed image parts and used to identify any anomalies without introducing significant error in the inspection analysis. For example, a product known to be contaminant free is placed in the inspection device and a reject threshold is set which lies slightly beyond the maximum darkness of the profiles of the processed image. Any part of a profile which falls beyond the background the reject threshold is considered to be a contaminant and so is flagged up. A reject/accept decision can then be made. An advantage of the present invention is that the image processing (including reject threshold detection) can be applied independently to each part of the image representing products in each lane of a multi-lane inspection machine. Thus, the machine can ensure product integrity simultaneously for a range of very different products without the need to change the power of the penetrating radiation.

### EXAMPLE

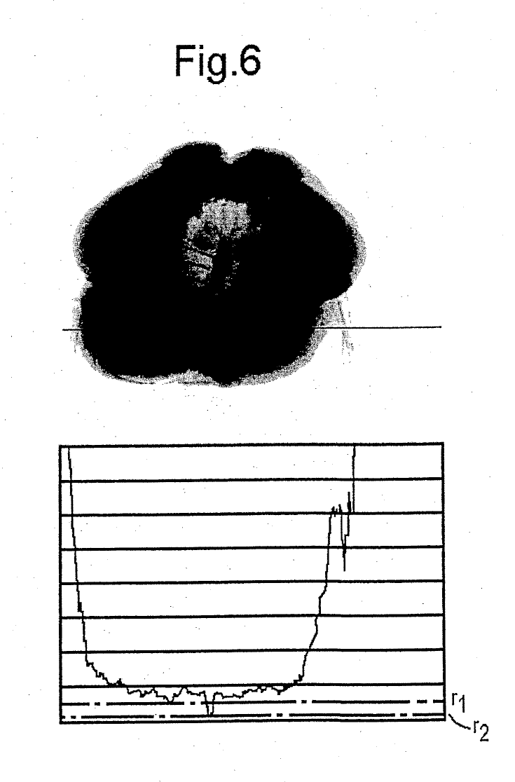

The uncooked chicken and contaminant test piece described above are passed along lanes A and B of an inspection apparatus as described above having Gamma and RANGE values set for each lane as described above with reference to FIG. 3 (Lane A: Gamma=1.0, RANGE=100%; Lane B: 1.0/Gamma=2.4, RANGE=100%). The image part which represents the chicken in Lane A, is shown in FIG. 6. As before, this image appears too dark and the ball bearing is not easily visible. This is also reflected in the image profile below in the bottom part of FIG. 6. A background minimum brightness level which represents the uncontaminated chicken is determined as shown by the reference line r₁, brightness=12. A contamination minimum brightness level is determined as shown by the reference line r₂, brightness level=4, passing through the tip of the small darkness spike caused by the ball bearing. The distance between the lines r₁ and r₂ represents the effective discrimination range in which the contaminant is detected, without false positives from the chicken. This range has a value of 8 which is small so that there is a significant likelihood of detection errors in use in a production environment.

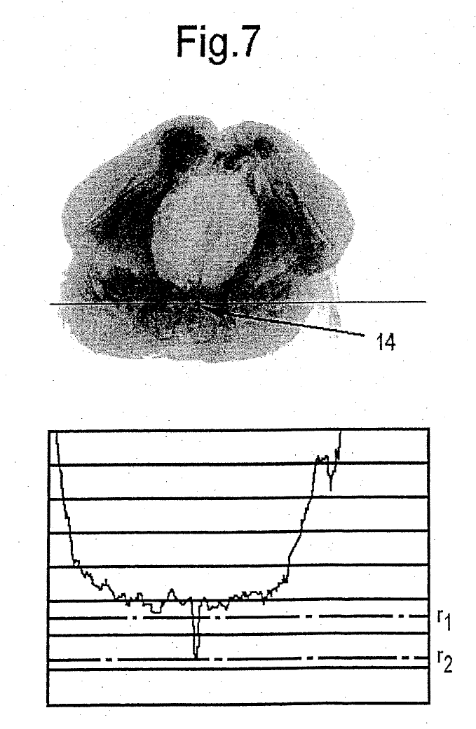

The image part which represents the chicken in Lane B is shown in FIG. 7. The image part appears lighter and thus the ball bearing 14 can be easily seen. Using the same profiling technique the background reference line rₜ has a brightness of 71 and the contamination reference line r₂ line has a brightness of 41, giving a much bigger and more reliable discrimination range of 30 represented by the contaminant, i.e. from 71 (background) to 41 (contaminant). The rejection threshold can be set approximately midway between the r₁ and r₂ brightness values, at 56, say, to give robust and reliable contaminant detection in use in the production environment.

1. A method of inspection comprising the steps of:
a) acquiring an image of an inspection zone;
b) numerically processing the image, in which first and second parts of the image are subjected to independent numerical processing;
c) passing a first series of items through the inspection zone so as to appear in the first part of the image, and
d) passing a second series of items through the inspection zone so as to appear in the second part of the image.

2. A method of inspection as claimed in claim 1 in which the first and second image parts correspond to different lanes.

3. A method of inspection as claimed in claim 1 wherein said numerical processing comprises performing contrast enhancing treatment to each or one of the first and second parts of the image.

4. A method of inspection as claimed in claim 3 wherein the contrast enhancing treatment makes any one of a product anomaly or a contaminant or a foreign body more visible.

5. (canceled)

6. (canceled)

7. (canceled)

8. (canceled)

9. (canceled)

10. (canceled)

11. A method of inspection as claimed in claim 1 wherein in one or more of the first and second image parts, in areas of that image part having a brightness greater than a threshold value, image data are set to the maximum image brightness.

12. A method of inspection as claimed in claim 11 wherein said threshold value is determined by applying a range factor to an image data target calibration value.

13. A method of inspection as claimed in claim 16 wherein the image data target calibration value is determined without the presence of any items in the inspection zone.

14. A method of inspection as claimed in claim 16 wherein the range factor is substantially from 20% to 120%.

15. A method of inspection as claimed in claim 11, comprising the steps of
numerically processing image data below the threshold value.

16. A method of inspection as claimed in claim 15 wherein the numerical processing comprises using the algorithm:
processed data value=Maximum processed data value×(unprocessed data value/threshold value)^{(1.0/Gamma)}

17. A method of inspection as defined in claim 1 in which the presence of anomalies in the items are determined using automatic threshold detection.

18. Inspection apparatus comprising an inspection zone, means for acquiring an image of the inspection zone, means operatively arranged to numerically process first and second parts of the image independently, means for passing a first series of items through the inspection zone so as to appear in the first part of the image, and means for passing a second series of items through the inspection zone so as to appear in the second part of the image.

19. Inspection apparatus as defined in claim 18, in which the means for passing the first and second series of items through the inspection zone comprises a plurality of lanes.

20. (canceled)

21. (canceled)

22. (canceled)

23. (canceled)

24. (canceled)

25. (canceled)

26. (canceled)
